(19) United States
(12) Patent Application Publication
(10) Pub. No.: US 2026/0326063 A1
(43) Pub. Date: Oct. 22, 2026

(54) VERTICAL, MULTI-STAGE, COUNTERCURRENT FLUIDIZED BED

(71) Applicant: Albemarle Corporation, Charlotte, NC (US)

(72) Inventors: Andrew J. Loebl, Kings Mountain, NC (US); Trent Elkins, Kings Mountain, NC (US); S.B. Reddy Karri, Chicago, IL (US); John Findlay, Chicago, IL (US)

(73) Assignee: Albemarle Corporation, Charlotte, NC (US)

(21) Appl. No.: 19/690,593

(22) Filed: May 28, 2026

(51) Int. Cl. B01J 8/28; B01J 8/00; B01J 8/18; C01B 17/22; C01D 15/08

(52) U.S. Cl. CPC B01J 8/28; B01J 8/003; B01J 8/0055; B01J 8/1827; C01B 17/22; C01D 15/08; B01J 2208/00752; B01J 2208/0084; B01J 2208/00938; C01P 2006/80

(57) ABSTRACT

The technology includes a method and an apparatus to react a gas with solids in a fluidized bed. The fluidized bed apparatus includes a first section stacked vertically on a second section, where the first section and the second section each comprise a fluidized bed of solids, a solids overflow for transporting solids from a top of the fluidized bed of the first section to the fluidized bed of the second section, and a gas inlet that directs a gas countercurrently to a flow of the solids through the fluidized bed of the second section and through the fluidized bed of the first section. Additional sections may be vertically stacked to increase the residence time of the solids. In an example, the solids include lithium hydroxide and the gas includes hydrogen sulfide to produce lithium sulfide.

### TECHNICAL FIELD

This disclosure relates to an apparatus and a method to react compounds in multi-stage fluidized beds.

### BACKGROUND

Lithium sulfide is a key precursor and active material in lithium-sulfur batteries, solid electrolytes, and other specialty chemical applications. High-purity lithium sulfide is required to achieve desired electrochemical performance, particularly in next-generation battery systems where impurities can adversely affect conductivity, stability, and cycle life.

Conventional methods for producing lithium sulfide generally involve direct reaction of lithium metal with sulfur. Another conventional method includes metathesis or precipitation reactions, such as reacting lithium salts with hydrogen sulfide (H₂S) or sulfide sources. These conventional approaches often suffer from incomplete reactions, formation of by-products (e.g., Li₂SO₃, Li₂SO₄), and challenges in removing residual moisture and contaminants. Another conventional method includes solid-state thermal conversion, where lithium carbonate or lithium hydroxide is reacted with sulfur or sulfur-bearing gases at high temperature. These solid-solid reactions are diffusion-limited, require long residence times, and tend to produce inhomogeneous product distributions.

Fluidized bed reactors are used in this and other industries, such as catalysts, metallurgical processing, and gas-solid reaction engineering, for their efficient heat transfer, uniform temperature distribution, and ability to maintain solids in a well-mixed, reactive state. However, existing lithium sulfide production processes do not adequately address issues to allow scaling of fluidized bed reactors to industrial scale production rates. Existing reactors have issues such as such as inefficient gas-solid contact leading to incomplete conversion and poor thermal management causing localized overheating, agglomeration, or decomposition.

Achieving a desired 99% conversion rates of industrial scale throughput using existing fluidized bed reactor technology would require reactors that are either too large to be practical or overly complicated with multiple stages in a single horizontal reactor. A need exists in the industry for a more efficient and simpler reactor design.

### BRIEF SUMMARY

This summary lists several embodiments of the presently disclosed subject matter, and in many cases lists variations and permutations of these embodiments. This summary is merely exemplary of the numerous and varied embodiments. The mention of one or more representative features of a given embodiment is likewise exemplary. Such an embodiment can typically exist with or without the feature(s) mentioned; likewise, those features can be applied to other embodiments of the presently disclosed subject matter, whether listed in this summary or not. To avoid excessive repetition, this Summary does not list or suggest all possible combinations of such features.

In one aspect, a fluidized bed apparatus includes a first section stacked vertically on a second section, where the first section and the second section each include a fluidized bed of solids, a solids overflow for transporting solids from a top of the fluidized bed of the first section to the fluidized bed of the second section, a gas inlet that directs a gas countercurrently to a flow of the solids through the fluidized bed of the second section and through the fluidized bed of the first section, one or more metal components with a plurality of orifices configured to disrupt and disperse large bubbles of the gas, and one or more metal components configured to provide surface area for heat transfer and circulation of heat transfer fluid.

In another aspect, the fluidized bed apparatus includes a feed inlet to the fluidized bed of the first section from a feed source of the solids. In another aspect, the fluidized bed apparatus includes a distributor plate under the fluidized bed of the first section and a distributor plate under fluidized bed of the second section. In another aspect, the distributor plate includes a plurality of nozzles. In another aspect, the nozzles comprise a plurality of orifices through which the gas is distributed at velocities below 200 ft/s. In another aspect, the fluidized beds of the first section and the fluidized bed of the second section comprise one or more baffles to narrow the residence time distribution.

In another aspect, a top portion of the first section includes an expanded section in which a diameter of the expanded section is greater than a diameter of the first section that includes fluidized bed of the first section. In another aspect, the fluidized bed apparatus includes a cyclone to remove entrained solids in the gas after the gas exits the first section. In another aspect, the removed entrained solids are recycled to fluidized bed of the first section.

In another aspect, the second section is stacked vertically on a one or more additional sections, each of which are stacked vertically. In another aspect, a bottom section includes a solids outlet that receives an overflow from a fluidized bed of the bottom section as a reacted product lithium sulfide.

In another aspect, the solids provided to the fluidized bed apparatus is lithium hydroxide. In another aspect, the gas provided to the fluidized bed apparatus is hydrogen sulfide. In another aspect, a product of the reaction of the solids and the gas is lithium sulfide. In another aspect, a conversion of the lithium hydroxide to lithium sulfide in the fluidized bed apparatus is greater than 99.7%.

In another aspect, a method is provided to react a gas with solids in a fluidized bed apparatus. The method includes providing solids to a first section that is stacked vertically on one or more subsequent sections, wherein the first section and the one or more subsequent sections each comprise a fluidized bed of solids and wherein the one or more subsequent sections are stacked vertically over a bottom section, providing a gas configured to react with the solids to a fluidized bed of the bottom section, configuring the fluidized bed apparatus such that the gas flows countercurrently to the solids, and collecting reacted solids from the fluidized bed of the bottom section.

These and other steps will be discussed in detail below. Thus, the conduct of one or more additional steps beyond those described herein in performing a multi-step process of the present disclosure falls within the scope of the claim coverage of this present disclosure.

The above and other embodiments, objectives, features, and advantages of this present disclosure will become still further apparent from the ensuing description, appended claims, and accompanying drawings.

### BRIEF DESCRIPTION OF THE SEVERAL VIEWS OF THE DRAWINGS

The presently disclosed subject matter can be better understood by referring to the following example figures. The components in the figure are not necessarily to scale, emphasis instead being placed upon illustrating the principles of the presently disclosed subject matter (often schematically). In the figures, like reference numerals designate corresponding parts throughout the different views. A further understanding of the presently disclosed subject matter can be obtained by reference to an embodiment set forth in the illustrations of the accompanying drawing. Although the illustrated embodiment is merely for purposes of example of systems for carrying out the presently disclosed subject matter, both the organization and method of operation of the presently disclosed subject matter, in general, together with further objectives and advantages thereof, may be more easily understood by reference to the drawings and the following description. The drawings are not intended to limit the scope of this presently disclosed subject matter, which is set forth with particularity in the claims as appended or as subsequently amended, but merely to clarify and provide examples of the presently disclosed subject matter.

FIG. 1 illustrates a multi-stage, countercurrent fluidized bed reactor in accordance with one embodiment.

FIG. 2 illustrates a distributor plate in a cross section of a fluidized bed reactor in accordance with one embodiment.

FIG. 3 illustrates a side cross section of a distributor plate in accordance with one embodiment.

FIG. 4 illustrates three options for baffles in accordance with multiple embodiments.

FIG. 5 illustrates a single stage of a fluidized bed reactor with an expanded section over the level of the solids outlet in accordance with one embodiment.

FIG. 6 illustrates a staggered, multi-stage, countercurrent fluidized bed reactor in accordance with one embodiment.

FIG. 7 illustrates a conventional fluidized bed reactor in accordance with one embodiment.

FIG. 8 illustrates a conventional fluidized bed reactor in accordance with one embodiment.

### DETAILED DESCRIPTION

### Definitions

The terminology used herein is for the purpose of describing particular embodiments only and is not intended to be limiting of the presently disclosed subject matter.

While the following terms are believed to be well understood by one of ordinary skill in the art, the following definitions are set forth to facilitate explanation of the presently disclosed subject matter.

All technical and scientific terms used herein, unless otherwise defined below, are intended to have the same meaning as commonly understood by one of ordinary skill in the art. References to techniques employed herein are intended to refer to the techniques as commonly understood in the art, including variations on those techniques or substitutions of equivalent techniques that would be apparent to one of skill in the art.

Components referred to by chemical name or formula anywhere in the specification or claims hereof, whether referred to in the singular or plural, are identified as they exist prior to coming into contact with another substance referred to by chemical name or chemical type (e.g., another component, a solvent, etc.). It matters not what chemical changes, transformations and/or reactions, if any, take place in the resulting mixture or solution as such changes, transformations, and/or reactions are the natural result of bringing the specified components together under the conditions called for pursuant to this disclosure. Thus, the components are identified as ingredients to be brought together in connection with performing a desired operation or in forming a desired composition. Also, even though the claims hereinafter may refer to substances, components and/or ingredients in the present tense (“comprises”, “is”, etc.), the reference is to the substance, component or ingredient as it existed at the time just before it was first contacted, blended or mixed with one or more other substances, components and/or ingredients in accordance with the present disclosure. The fact that a substance, component or ingredient may have lost its original identity through a chemical reaction or transformation during the course of contacting, blending or mixing operations, if conducted in accordance with this disclosure and with ordinary skill of a chemist, is thus of no practical concern.

In describing the presently disclosed subject matter, it will be understood that a number of techniques and steps are disclosed. Each of these has individual benefit and each can also be used in conjunction with one or more, or in some cases all, of the other disclosed techniques.

Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

Following long-standing patent law convention, the terms “a”, “an”, and “the” refer to “one or more” when used in this application, including the claims. Thus, for example, reference to “a cell” includes a plurality of such cells, and so forth.

Unless otherwise indicated, all numbers expressing quantities of ingredients, reaction conditions, and so forth used in the specification and claims are to be understood as being modified in all instances by the term “about”. Accordingly, unless indicated to the contrary, the numerical parameters set forth in this specification and attached claims are approximations that can vary depending upon the desired properties sought to be obtained by the presently disclosed subject matter.

As used herein, the term “about,” when referring to a value or to an amount of a composition, dose, mass, weight, temperature, time, volume, concentration, percentage, etc., is meant to encompass variations of in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed methods or employ the disclosed compositions.

The term “comprising”, which is synonymous with “including” “containing” or “characterized by” is inclusive or open-ended and does not exclude additional, unrecited elements or method steps. “Comprising” is a term of art used in claim language which means that the named elements are essential, but other elements can be added and still form a construct within the scope of the claim.

As used herein, the phrase “consisting of” excludes any element, step, or ingredient not specified in the claim. When the phrase “consists of” appears in a clause of the body of a claim, rather than immediately following the preamble, it limits only the element set forth in that clause; other elements are not excluded from the claim as a whole.

As used herein, the phrase “consisting essentially of” limits the scope of a claim to the specified materials or steps, plus those that do not materially affect the basic and novel characteristic(s) of the claimed subject matter.

With respect to the terms “comprising”, “consisting of”, and “consisting essentially of”, where one of these three terms is used herein, the presently disclosed and claimed subject matter can include the use of either of the other two terms.

As used herein, the term “and/or” when used in the context of a listing of entities, refers to the entities being present singly or in combination. Thus, for example, the phrase “A, B, C, and/or D” includes A, B, C, and D individually, but also includes any and all combinations and subcombinations of A, B, C, and D.

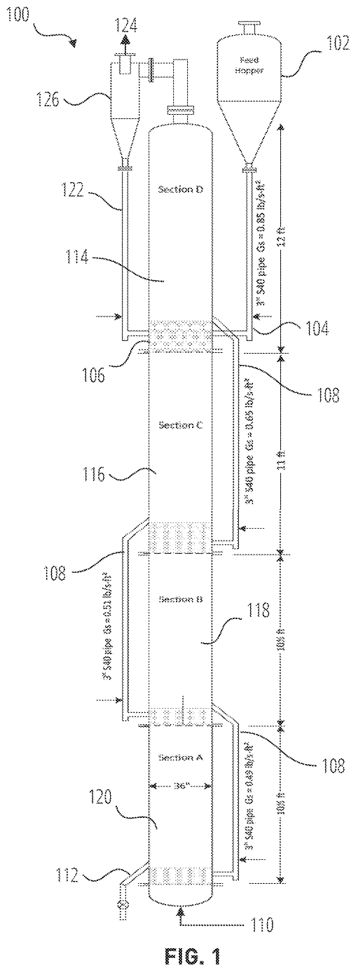

FIG. 1 illustrates a multi-stage, countercurrent fluidized bed reactor apparatus 100 in accordance with one embodiment.

In the illustration, four sections of the apparatus 100 are stacked vertically with top section, section D 114, above section C 116, which is above section B 118, which is above section A 120. In some examples, the sections are referred to as stages. These terms are used interchangeably. In each section, a fluidized bed of solids 106 is provided. In the primary example of the specification, the solids 106 include lithium hydroxide.

Gas inlet 110 illustrates a location at which a gas is fed to the apparatus 100 to flow through the solids 106. In the example, the gas may be hydrogen sulfide (H₂S). A solids outlet 112 receives an overflow of the lowest stage of the apparatus 100; in this example the lowest stage is section A 120. The solids exiting via the solids outlet 112 in the example includes particles of lithium sulfide solid. The lithium hydroxide product may be converted from lithium hydroxide at least at a desired percentage of lithium sulfide. In an example, the solids are converted to at least 80% lithium sulfide, greater than 80% lithium sulfide, greater than 85% lithium sulfide, greater than 95% lithium sulfide, preferably greater than 99% lithium sulfide, and even more preferably equal to or greater than 99.7% lithium sulfide.

In another example, the gas is carbon dioxide. The reaction of the lithium hydroxide and the carbon dioxide produces lithium carbonate. In any of the examples or processes described herein, the gas may be carbon dioxide instead of hydrogen sulfide to produce lithium carbonate.

Components of the apparatus 100 may include a feed hopper 102 that provides a supply of solids 106 via a feed pipe 104 to section D 114 of the example apparatus 100. The feed hopper 102 may be elevated to provide a gravity feed of the solids 106 or use any other motive force. The feed pipe 104 provides the solids 106 to a lower section of section D 114 to be combined with the solids 106 in the fluidized bed. The solids 106 may rest on a distributor plate or other support apparatus. The gas is fed to a bottom portion of the solids 106 to cause the gas to rise upwards through the solids 106.

The solids 106 are of a configured particle size, density, temperature, and moisture content to cause the solids 106 to act as a fluidized bed when the gas is passing through the solids 106. Baffles and distributor plates may be used to direct and manage the flow of gas through the solids 106. The solids 106 may be mixed by the typical behavior of a fluidized bed. These features are discussed in greater detail below. In some examples, the fluidized bed of solids 106 in each section may be between 18″ and 60″ in height. In an example, the solids 106 are from Geldart group A or group B. A description of Geldart groups A and group B may be found in Geldart, D. (1973), Types of Gas Fluidization. Powder Technology, 7, 285-292.

Within each section, the apparatus 100 may include system internals designed to break up bubbles that form in the bed of solids 106 as the gas rises. These components may maintain good mixing of the solids 106 and gases to maximize reaction rate by limiting mass-transfer limitations. The components may take the form of angle-bars of corrosion resistant metal with slots cut through them to shear bubbles, a series of tubes off set horizontally and vertically to divert and break bubbles, or any other suitable mechanical device. The components may additionally function as surfaces for heat transfer into the bed to maintain reaction temperature since the overall reaction is typically endothermic.

The level of the solids 106 in the fluidized bed increases as additional solids 106 are fed via the feed pipe 104. When the solids 106 level reaches a particular height, the top layer of solids 106 begins to overflow into the solids overflow 108. The solids overflow 108 carries the partially reacted solids 106 to the section immediately below the first section D 114; in this case the solids 106 are fed to section C 116. The solids 106 form or mix with the fluidized bed in section C and contact gas rising upwards from section B 118. The solids overflow 108 is configured to be sufficiently large such that no stable bridging of solids 106 occurs that could lead to a reverse flow of solids 106 that empties the downcomer and then stops the flow of solids 106. The necessary diameter is dependent on the composition of the particles, height of the beds in each section, and the pressure drop across the various distributors.

The process is repeated as overflow from the solids 106 of section C 116 overflow to fill the fluidized bed of section B 118, and then overflow to the fluidized bed of section A. The gas from the gas inlet 110 passes upwards through each subsequent section counter-currently, from section A 120 through section D 114.

In each subsequent section, as the solids 106 flow to a lower section, the percentage conversion of the lithium hydroxide to lithium sulfide is higher. As the gas flows upwards the amount of H2S converted to water increases. The composition of the gas entering the apparatus 100 may be between 10 and 100 mol % H2S at the gas inlet 110 in the bottom of section A 120 and pre-heated to a temperature exceeding 200 C. In some examples, the composition of the gas entering the apparatus 100 may be between 10 and 50 mol % H2S at the gas inlet 110. The mass flow of hydrogen sulfide may preferably be between 2 or 3 times the minimum required flow based on the stoichiometry of the reaction. As such, the limiting factor of the reaction is the lithium hydroxide in the solids 106. The majority of the remaining gas may include an inert gas, such as nitrogen. The concentration of water and carbon dioxide entering the reactor may preferably be less than 1 mol % each.

When the overflow of solids 106 in section A 120 occurs, the solids 106 exit the apparatus 100 via the solids outlet 112. The solids outlet 112 may capture the solids 106 for delivery to any suitable destination as a product of lithium sulfide with a percent conversion over the configured threshold.

The gas exits section D 114 at a top section of the apparatus 100. The gas may have entrained water, fine particles of solids 106, or other particulates. The gas may enter a cyclone 126 or other process equipment that may remove any particulates from the gas. The gas may exit the process via the gas outlet 124 and be directed to a gas emissions control or other location for disposal or further use. In one alternative example, the gas is recycled to the gas inlet 110. As not all of the H₂S is typically converted during a single pass through the apparatus 100 the process, the gas may be reused in the apparatus 100.

In one example, the fine particles of solids 106 captured in the cyclone 126 may be directed back to the fluidized bed of section D 114 via fines recycle 122. The cyclone 126 may be designed to remove over 95% of any small, fine particles smaller than 100 um in diameter to protect downstream equipment.

In an example, the fines are recycled to increase the yield of lithium sulfide solids. In some examples, the fines may be recycled to any of the stages of the apparatus 100. In other examples, none of the fines are recycled. However, the fines recycle 122 or section D 114 may require additional process considerations, such as a purge system, to prevent a buildup of fines in section D 114.

As illustrated, the solids 106 are fed to each section of the apparatus 100 via gravity. However, in some examples additional motive forces may be applied such as augers, air pressure applications, or other motive forces.

In some examples, the apparatus 100 is a vertical stack of cylindrical pipe made of a suitable corrosion resistant metal, such as Hastelloy C2 76. The apparatus 100 may be designed to operate between 0 and 10 barg of relative pressure and with a solids temperature up to 370 C. The diameter of the pipe may be 6″ or larger, typically limited by the ability to manufacture very large diameter pipe from exotic alloys and the economics of a suitably strong foundation. At full commercial scale the apparatus 100 may be between 60″ and 96″ in diameter. In some examples, the height of each section, such as section D 114, may be 8 to 12 feet in height.

The apparatus 100 and superficial gas velocity may be sized to target a gas-solid contact time across the full height of each fluidized bed stage of between 1 and 20 seconds. Solids residence time across the full system would be expressed as a factor tau, the ratio of the total solids hold-up in the reactor and the hourly solids flow into the unit. The value of tau may preferably range between 2 and 16 hours with baffling used to narrow the average residence time around a desired amount of time.

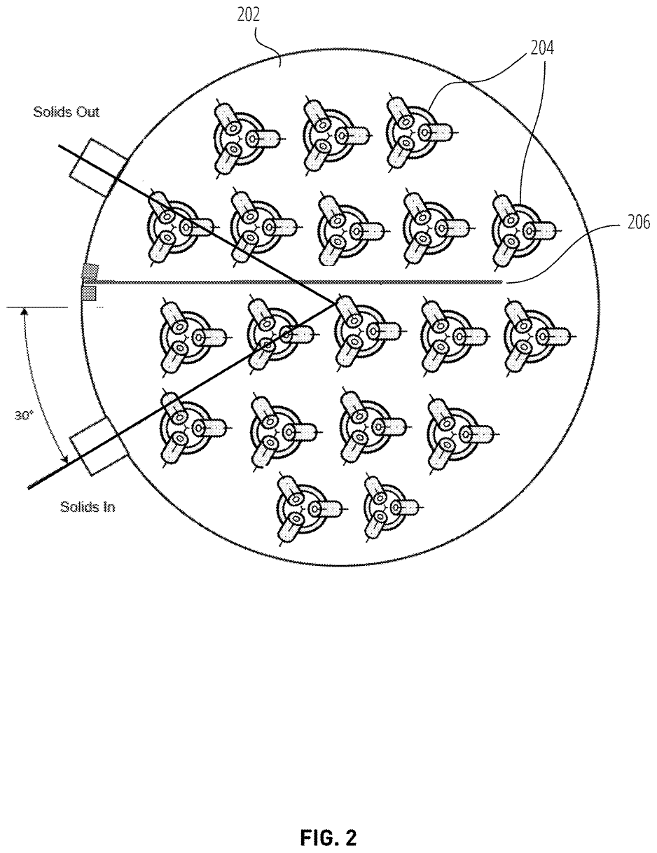

FIG. 2 illustrates a distributor plate 202 in a cross section of a fluidized bed reactor in accordance with one embodiment.

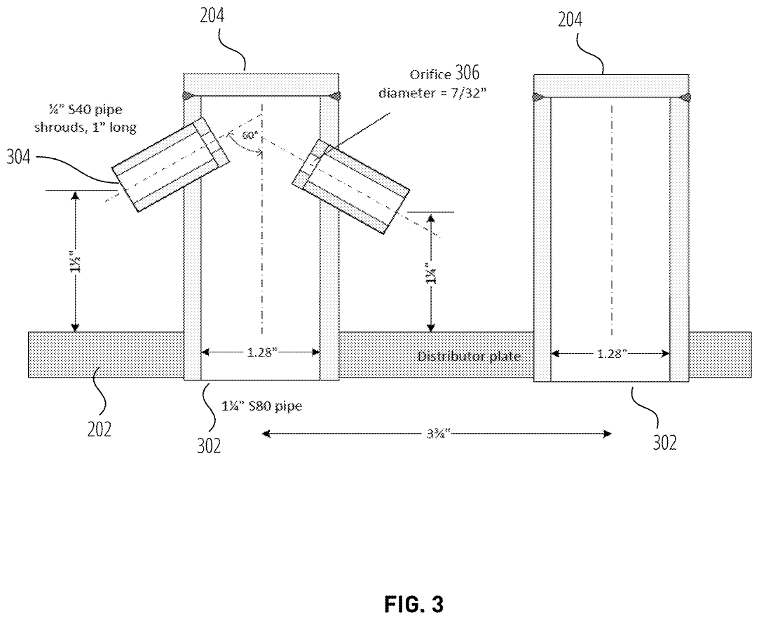

The distributor plate 202 may be located at a bottom portion of each section of the apparatus 100. In the example, the solids 106 in each section rest on the distributor plate 202. The gas flowing upwards passes through the nozzles 204 on the distributor plate 202. By forcing the gas to enter the solids 106 at multiple distributed locations, each location providing a small orifice for entry, the gas is prevented from forming larger bubbles or other formations that prevent sufficient contact with the solids 106. The gas entering the fluidized bed through the distributor plate 202 is properly distributed throughout the solids 106 to contact the solids 106 evenly and without bubbles. The nozzles 204 are further illustrated in FIG. 3 herein.

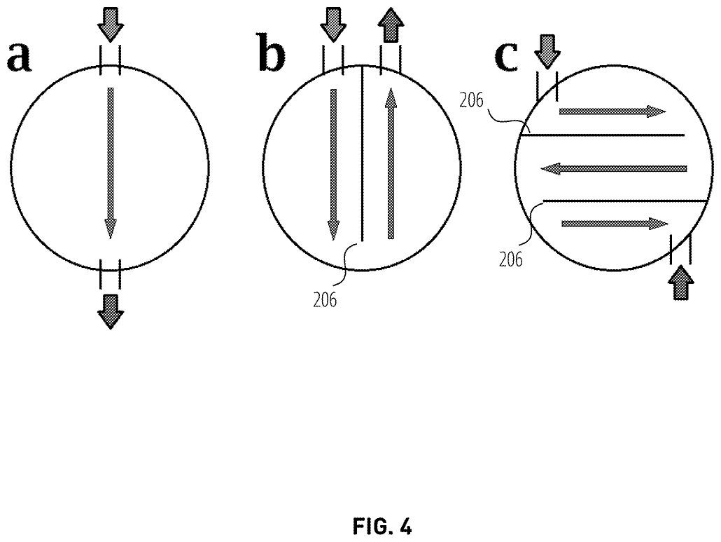

The distributor plate 202 may also support one or more baffles 206. The baffle 206 in the illustration is a vertical plane that extends from the distributor plate 202 to a height at least as high as the solids 106 content. The baffle 206 forces the solids 106 that are rising through each section of the apparatus 100 to travel from the entry point, around the baffle 206, and back to the solids overflow 108 to exit the section. The entry point for the solids 106 to enter may be the feed pipe 104 for the top section D 114 or a feed from a solids overflow 108 from a higher sections, such as for section C 116, section B 118, or section A 120. The baffle 206 causes the solids 106 to traverse the U-shaped flow path to allow for the contact time between the solids 106 and the gas to be more precisely controlled. That is, the baffle 206 causes the residence times distribution of the solids 106 to be narrowed. Additional options for the baffle 206 are provided in FIG. 4.

Any configurable number of nozzles 204 may be placed on the distributor plate 202. In some examples, the distributor plate 202 is designed to maintain gas jet velocity below 100 ft/s to avoid micronization of the solids 106 and minimize weeping of solids 106. Adjusting the orifice sizes on the nozzles 204, the number of nozzles 204, and

FIG. 3 illustrates a side cross section of a distributor plate 202 in accordance with one embodiment.

The nozzles 204 are illustrated as including a nozzle inlets 302 distributed about on a distributor plate 202. The nozzle 204 is configured as a cylinder with an open bottom at the nozzle inlet 302. The nozzles 204 include one or more nozzle outlets 304 that allow the gas to exit the nozzle 204. The orifices 306 and the nozzle outlets 304 may be sized to cause the gas to be dispersed in the solids 106 evenly and at a desired rate.

In the example, the gas rises upwards from a lower section of the apparatus 100 and enters the nozzle inlet 302 and rises upwards to the top of the nozzle 204. The gas travels through the orifice 306 and exits the nozzle outlet 304. In the example, because the nozzle outlet 304 is pointed downward, the solids 106 surrounding the nozzles 204 will not enter the nozzle outlet 304.

Any suitable number of nozzles 204 may be incorporated with the distributor plate 202 based on the size, type, depth, and other characteristics of the solids 106 and the volume, flow rate, temperature, or other characteristics of the gas. For example, more nozzles 204 may be required for a heavier, denser solids 106 content.

FIG. 4 illustrates three options for baffles 206 in accordance with multiple embodiments.

Each example A, B, and C, is illustrated as a top cross section view of the fluidized bed in a section. In example A, no baffles 206 are used in the apparatus 100. In this example, the solids 106 enter in a bottom of a section and rise up and and across the section as more solids 106 are fed into the section, such as by a solids overflow 108 from a higher section.

In example B, a single baffle 206 is placed in the middle of the section. As in FIG. 2, the baffle 206 is configured in a vertical plane for at least the depth of the solids 106. In this example, the solids 106 must travel in a U-shape to navigate around the baffle 206 and back to the solids overflow 108 to exit the section.

In example C, two baffles 206 are placed in the middle of the section. As in FIG. 2, the two baffles 206 are configured in a vertical plane for at least the depth of the solids 106. In this example, the solids 106 must travel in an S-shape to navigate around each of the baffles 206 and back to the solids overflow 108 to exit the section.

The additional distance the solids 106 must flow to exit the section allows for additional and more consistent contact with the gas that is flowing through the solids 106. The additional contact may result in a greater conversion of the solids 106.

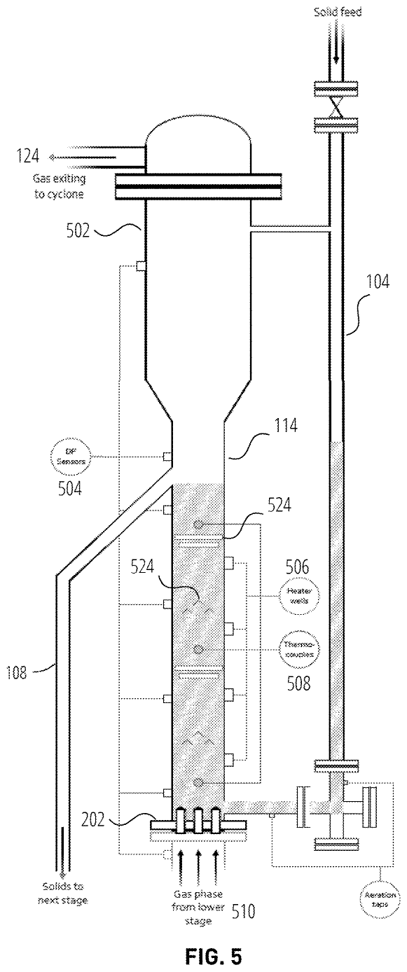

FIG. 5 illustrates a single stage of a fluidized bed reactor with an expanded section over the level of the solids outlet in accordance with one embodiment.

The illustration may be configured to operate similarly to section D 114 of FIG. 1. For example, a feed pipe 104 delivers solids 106 to the section at a bottom of the solids 106. The gas exits at the gas outlet 124. The solids 106 exits at the solids overflow 108 to a lower section. Other features are illustrated such as the pressure sensors 504. The pressure sensors 504 may be any suitable sensor that is mounted on the section D 114 or inserted into the body of the section D 114. Heater wells 506 are illustrated as being mounted on the section D 114 to provide heating to the solids 106 in the section D 114. The heating elements may be any suitable heater technology, such as an electric element or a steam-based element. Temperature sensors 508 are illustrated as being mounted on the section D 114 to monitor the temperature of the section D 114. The temperature sensors 508 may be any suitable temperature sensing technology, such as a thermocouple or an RTD.

The expanded section 502 of section D 114, above the solids level, is illustrated as being expanded from the diameter of the section of section D 114 that is at the solids level. The expanded section 502 may allow entrained solids in the gas to fall out of entrainment before the gas leaves section D 114. For example, the expanded section 502 causes the residence time of the gas to increase inside section D 114 with an accompanying reduction in gas velocity to promote further disentrainment. The increased time may allow for the fines or other solids 106 in the gas to fall back to the level of the solids 106. In an example, the expanded section may be from 1.5 to 2.5 times the diameter of the portion of section D 114 containing the fluidized bed.

Mechanical components 524 are illustrated that may maintain good mixing of the solids 106 and gases to maximize reaction rate by limiting mass-transfer limitations. The mechanical components 524 may take the form of angle-bars of corrosion resistant metal with slots cut through them to shear bubbles, a series of tubes off set horizontally and vertically to divert and break bubbles, or any other suitable mechanical device. The mechanical components 524 may additionally function as surfaces for heat transfer into the bed to maintain reaction temperature since the overall reaction is endothermic.

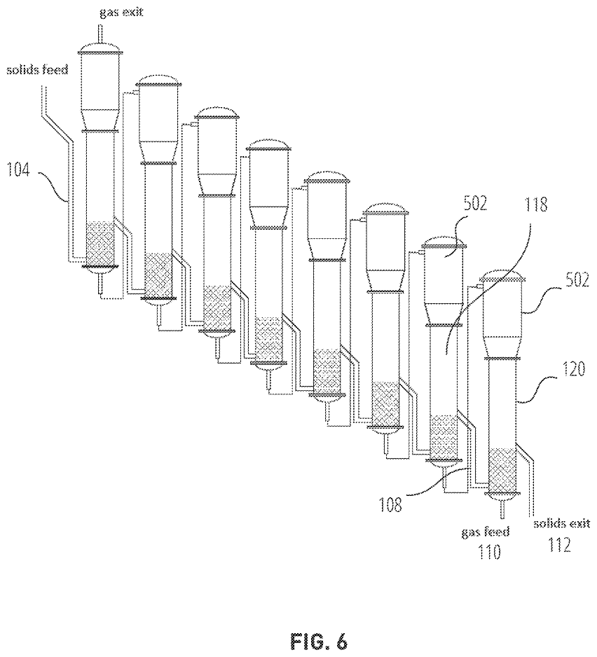

FIG. 6 illustrates a staggered, multi-stage, countercurrent fluidized bed reactor in accordance with one embodiment.

The illustrated example has similar elements as the apparatus 100 of FIG. 1, except that the sections are staggered and not directly above each subsequent section. The sections, while not being directly stacked upon each other, are still raised to keep level of each subsequent section higher than the section below. This allows the solids 106 in the solids overflow 108 to maintain a head of pressure to feed the solids 106 into the section below.

One benefit of this arrangement is that each section may include an expanded section 502. When the sections are stacked, the expanded sections 502 may be difficult to construct and maintain due to mechanical factors.

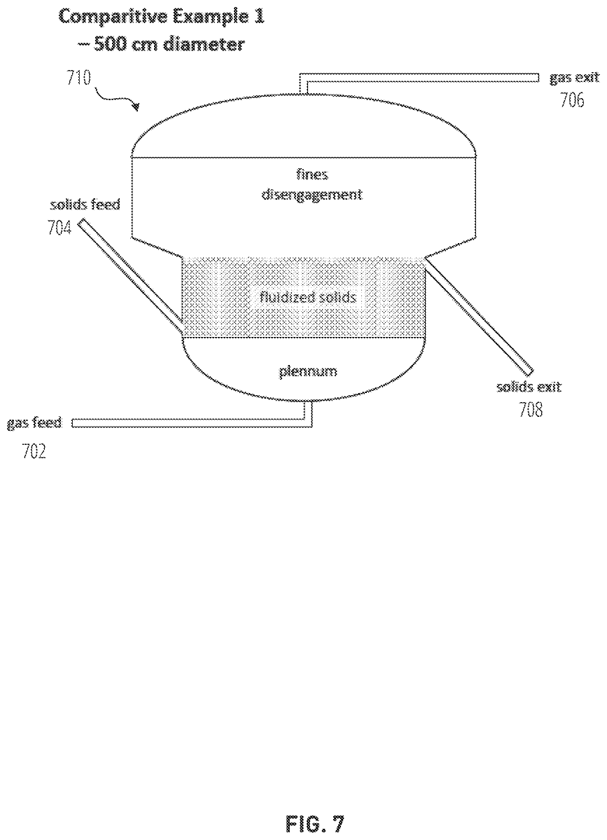

FIG. 7 illustrates a conventional fluidized bed reactor 710 in accordance with one embodiment.

This comparative example 1 illustrates a single stage fluidized bed. The reactor 710 has similar features as the technology described herein, such as a gas inlet 702, a solids exit 708, a gas exit 706, and a solids feed 704.

The ratio of the feed to the volume of the reactor 710, to reach greater than 99% conversion must be 1 kg/hr per 100 kg of solids held due to single CSTR fundamentals. Thus, to reach a small demonstration production rate of 15 kg/hr (approximately 100 metric tons per year) would require 15,000 kg of solids occupying 30 m³ of space. This example reactor 710 could be a single vessel 3 m in diameter and 7 m tall plus additional freeboard. The solids would have an average residence time of 100 hours while the majority of product would be expected to be fully reacted in 8 hours or less. The capital and operating efficiency of such a unit is would not be cost effective or reasonable since 90% of the material will be held up without progressing the reaction.

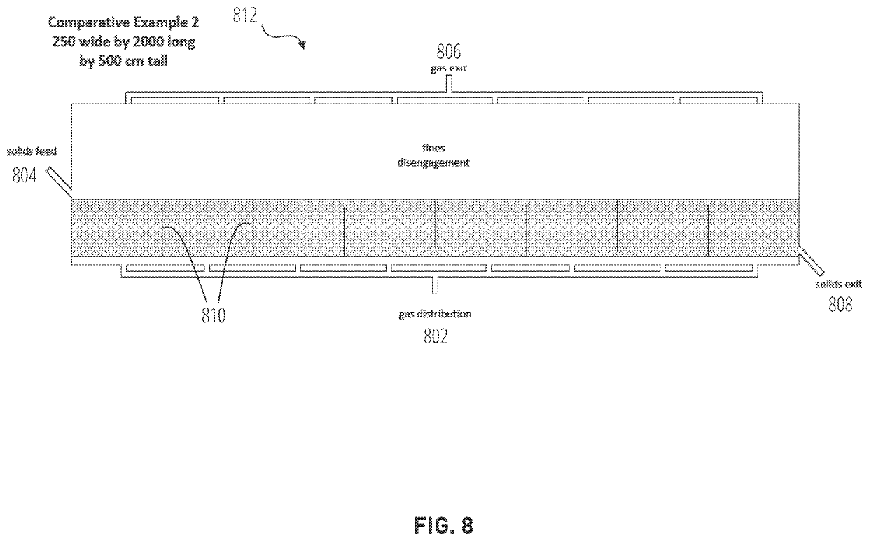

FIG. 8 illustrates a conventional fluidized bed reactor 812 in accordance with one embodiment.

This comparative example 2 illustrates a single stage fluidized bed. The reactor 812 has similar features as the technology described herein, such as a gas inlet 802, a solids exit 808, a gas exit 806, and a solids feed 804. The reactor 812 includes baffles 810 that cause the solids 106 to traverse from left to right over and under each subsequent baffle 810.

Compared to a conventional reactor, this style of reactor 812 will improve solids hold-up and reactor capital efficiency at the cost of significant gas processing complexity and cost. A unit processing 15 kg/hr would need to hold 120 kg of solids across 8 stages. This is solids efficient, but fluidization of the solids in 8 stages increases the gas clean-up and recycle by that same factor of 8 when compared to the technology described herein that obtains the same solids efficiency. This gas flow would require cooling, removal of water, purging of accumulated contaminants, and recompressing to return to the reactor. Initial estimates suggest this would require 130 SCFM of total gas flow at 2 barg pressure. Further, mechanically engineering a rectangular box for pressure operation is typically considered a poor practice, even at the pressures as low as 2 barg. This example is overly complex to design and operate and cost-prohibitive.

The following examples illustrate multiple apparatus 100 configurations. Each different feature or characteristic is described with each example. The results of the conventional processes illustrated in FIG. 7 and FIG. 8 and the results of the Examples 3 to 5 are illustrated in the Table 1.

### Example 3

This example includes multiple fluidized beds operating stacked, as illustrated in FIG. 1, to minimize gas requirements maximize gas utilization, and flow solids 106 external to the apparatus 100 body via solids overflow 108. The example unit is configured with 12 vertically stacked stages with the same volume of 8 stages holding a total of 120 kg of solids 106 but with only 22 SCFM of total gas flow (at 2 barg pressure). The solids 106 are comprised primarily of lithium hydroxide. The gas is comprised primarily of H₂S.

The vessel includes a round cross-section, which is preferred for pressurized operation. There is added complexity of the solids flow. The topmost stage would have an expanded section 502 to reduce fines carryover to any downstream cyclone. The gas flow in this arrangement is countercurrent to maximize reaction rate in the bottommost stage where the last bits of the reaction occur to reach completion.

### Example 4

This example includes multiple fluidized beds operating unstacked in series with equipment to redirect the gas, as illustrated in FIG. 6. If there were future maintenance or servicing issues associated with the stacked arrangement it could still be physically unstacked while vertically arranged to still operate in the counter-current style. The gas flow rate requirements in this system would be the same as Example 3 but would require additional piping to get from one stage to each subsequent stage. One potential benefit of this implementation is the ability to place a cyclone at the exit of each stage to collect any accumulating fines. This even makes it possible to skip any single stage during an extended maintenance while adjusting flows to maintain product quality.

### Example 5

This example includes multiple fluidized beds operating stacked, as illustrated in FIG. 1. The stages include either 1 or 2 baffles to multiply the benefit achieved by staging. These baffles create additional pseudo stages. Each stage is nearly bisected or trisected by a baffle to create sub-units acting as pseudo stages within any stage as illustrated in FIG. 4. In the case of a stacked 8-stage apparatus 100 with baffles acting as a 1.5 times multiplier, the production rate could increase from 15 kg/hr to 20 kg/hr for a 20% production rate improvement for the same capital cost. The larger the diameter of each section of the apparatus 100, the more baffles that could be reasonably included to potentially create higher stage multipliers. A diameter of 18″ or 24″ may be a preferred minimum feasible scale to include this feature for a single baffle. In other examples that include a diameter above 48″, a second baffle might be used.

The results of the conventional processes illustrated in FIG. 7 and FIG. 8 and the results of the Examples 1 to 3 are illustrated in the Table 1.

| | Comparative | Comparative | | | |
|---|---|---|---|---|---|
| | Example 1 | Example 2 | Example 3 | Example 4 | Example 5 |
| solids flow (k/hr) | 15 | 15 | 15 | 15 | 18 |
| solids held (kg) | 5000 | 120 | 120 | 120 | 120 |
| nominal residence | 330 | 8 | 8 | 8 | 6.7 |
| time (hr) | | | | | |
| gas flow (SCFM) | 550 | 180 | 22.5 | 22.5 | 22.5 |
| gas contact time and | short/poor | short/poor | long/good | long/good | long/good |
| utilization efficiency | | | | | |
| pressure balance | low | low | medium | high | medium |
| complexity | | | | | |
| compressors | large | medium | small | small | small |
| design for pressure | inherent | complex | inherent | inherent | inherent |
| operation | | | | | |

As can be seen in Table 1, the examples using the technology herein have superior characteristic to the comparative examples. Comparative example 1 required significantly more solids and gas flow, and had a longer residence time, large compressors, and poor contact time. Comparative example 2 required significantly more gas flow, and had larger compressors than the examples 3-5, complex designs for pressure operations, and poor contact time.

While the present disclosure has been described in terms of one or more preferred embodiments, it is to be understood that other modifications may be made without departing from the scope of the disclosure, which is set forth in the claims below.

What is claimed is:

1. A fluidized bed apparatus, comprising:
a first section stacked vertically on a second section, wherein the first section and the second section each comprise a fluidized bed of solids;
a solids overflow for transporting solids from a top of the fluidized bed of the first section to the fluidized bed of the second section;
a gas inlet that directs a gas countercurrently to a flow of the solids through the fluidized bed of the second section and through the fluidized bed of the first section.
one or more metal components with a plurality of orifices configured to disrupt and disperse large bubbles of the gas; and
one or more metal components configured to provide surface area for heat transfer and circulation of heat transfer fluid.

2. The fluidized bed apparatus of claim 1, further comprising a feed inlet to the fluidized bed of the first section from a feed source of the solids.

3. The fluidized bed apparatus of claim 1, further comprising a distributor plate under fluidized bed of the first section and a distributor plate under the fluidized bed of the second section.

4. The fluidized bed apparatus of claim 3, wherein the distributor plate comprises a plurality of nozzles.

5. The fluidized bed apparatus of claim 4, wherein the nozzles comprise a plurality of orifices through which the gas is distributed at velocities below 200 ft/s.

6. The fluidized bed apparatus of claim 1, wherein the fluidized beds of the first section and the fluidized bed of the second section comprise one or more baffles to narrow the residence time distribution.

7. The fluidized bed apparatus of claim 1, wherein a top portion of the first section comprises an expanded section in which a diameter of the expanded section is greater than a diameter of the first section comprising fluidized bed of the first section.

8. The fluidized bed apparatus of claim 1, further comprising a cyclone to remove entrained solids in the gas after the gas exits the first section.

9. The fluidized bed apparatus of claim 8, wherein the removed entrained solids are recycled to fluidized bed of the first section.

10. The fluidized bed apparatus of claim 1, wherein the second section is stacked vertically on a one or more additional sections, each of which are stacked vertically.

11. The fluidized bed apparatus of claim 10, wherein a bottom section comprises a solids outlet that receives an overflow from a fluidized bed of the bottom section as a reacted product.

12. The fluidized bed apparatus of claim 1, wherein the solids provided to the fluidized bed apparatus is lithium hydroxide.

13. The fluidized bed apparatus of claim 12, wherein the gas provided to the fluidized bed apparatus is hydrogen sulfide.

14. The fluidized bed apparatus of claim 12, wherein the gas provided to the fluidized bed apparatus is a mixture of hydrogen sulfide and one or more other gases.

15. The fluidized bed apparatus of claim 12, wherein the gas provided to the fluidized bed apparatus comprises hydrogen sulfide mixed with one or more of nitrogen and impurities.

16. The fluidized bed apparatus of claim 13, wherein a product of the reaction of the solids and the gas is lithium sulfide.

17. The fluidized bed apparatus of claim 16, wherein a conversion of the lithium hydroxide to lithium sulfide in the fluidized bed apparatus is greater than 80%.

18. The fluidized bed apparatus of claim 12, wherein the gas provided to the fluidized bed apparatus is carbon dioxide.

19. The fluidized bed apparatus of claim 18, wherein a product of the reaction of lithium hydroxide and carbon dioxide is lithium carbonate.

20. A method to react a gas with solids in a fluidized bed apparatus, comprising;
providing solids to a first section that is stacked vertically on one or more subsequent sections, wherein the first section and the one or more subsequent sections comprise a fluidized bed of solids and wherein the one or more subsequent sections are stacked vertically over a bottom section;
providing a gas configured to react with the solids to a fluidized bed of the bottom section;
configuring the fluidized bed apparatus such that the gas flows countercurrently to the solids and large bubbles of the gas are disrupted and dispersed;
providing heat via a surface area of one or more metal components; and
collecting reacted solids from the fluidized bed of the bottom section.

21. The method of claim 20, further comprising providing a solids overflow for transporting solids from a top of the fluidized bed of the first section to the fluidized bed of the second section.

22. The method of claim 20, further comprising directing the gas through a distributor plate under a fluidized bed of each section.

23. The method of claim 20, further comprising directing the gas through a cyclone after exiting the first section to remove particles of solids in the gas.

24. The method of claim 20, wherein the solids comprise lithium hydroxide and the gas comprises hydrogen sulfide.

25. The method of claim 20, wherein the solids comprise lithium hydroxide and the gas comprises carbon dioxide.
